(19) United States
(12) Patent Application Publication
(10) Pub. No.: US 2010/0163533 A1
(43) Pub. Date: Jul. 1, 2010

(54) INCREASING HEAD TRANSDUCTION VIA SURFACE PLASMON RESONANCE BY MODULATING RESONANT CONTINUOUS-WAVE IRRADIATION

(76) Inventors: Donald Keith Roper, Fayetteville, AR (US); Wonmi Ahn, Fayetteville, AR (US)

Correspondence Address: Workman Nydegger;1000 Eagle Gate Tower, 60 East South Temple, Salt Lake City, UT, 84111, US

(21) Appl. No.: 12/525,391

(22) PCT Filed: Jan. 24, 2008
(86) PCT No.: PCT/US08/51925

§ 371 Date: Jan. 26, 2010

Related U.S. Application Data
(60) Provisional application No. 60/898,827, filed on Jan. 31, 2007.

(51) Int. Cl. B23K 26/00

(52) U.S. Cl. 219/121.6

(57) ABSTRACT

The present invention relates to methods and apparatus for increasing the conversion efficiency of irradiation incident on metal particles to an ambient environment. More specifically the invention relates to methods and apparatus for increasing the heat conversion efficiency from irradiation incident on metal particles to an ambient environment through modulating radiation incident upon the metal particles.

### CROSS-REFERENCE TO RELATED APPLICATIONS

The present application claims priority from U.S. Provisional Patent Application Ser. No. 60/898,827 filed on Jan. 31, 2007, and entitled “Increasing Heat Transduction Via Surface Plasmon Resonance By Modulating Resonant Continuous-Wave Irradiation,” which is incorporated herein by reference in its entirety.

### GOVERNMENT RIGHTS

This invention was made with government support under 1R03 EB004886-01A1 awarded by NIH. The Government has certain rights to this invention.

### BACKGROUND OF THE INVENTION

Microscale thermal transport in colloidal noble metal nanoparticle suspensions is important in novel heat transfer fluids, laser-induced transformation of nanoparticle size, shape and phase, optothermal imaging, and targeted photothermal medical therapies such as photothermally activated drug delivery and photothermolysis of mammalian and bacterial cells. Suspended nanoparticles irradiated at resonant frequencies dissipate heat to the matrix in a cascade of events. Resonant irradiation induces a non-thermal electron distribution that thermalizes in ˜500 femtoseconds via elastic electron-electron scattering to an equilibrium Fermi electron distribution that corresponds to a higher electron temperature. The Fermi distribution or ‘electron gas’ cools by electron-phonon coupling with the noble metal lattice at a timescale of 2-5 picoseconds and by phonon-phonon interactions with surrounding medium at timescales between 100-380 picoseconds. Phonon-phonon interactions dissipate heat across a particle-matrix interface to an adjacent shell of matrix medium at a rate dependent on matrix, particle size and pump power as nanoparticles return to their initial electron temperature. Similar dynamics are observed in thin noble metal films.

High-power nano-, pico- and femto-second pump-probe spectroscopies that are used to excite nanoparticles and examine electron relaxation processes in noble metal nanoparticles and gold-silica nanoshells produce dynamic structural changes such as lattice vibration as well as interrelated proximal phenomena including particle melting and solvent vaporization that depend on laser intensity and duration and particle size. High-powered pulses shorter than a relaxation time of τ_{τ=r}ₚ²/6.75αₚ for spheres of radius rₚ and thermal diffusivity αₚ rapidly heat individual NPs which exhibit negligible conductive/convective and radiative heat loss on timescales <τ_{τ}. Heating thus confined to a nanoparticle (NP) subsequently superheats a thin layer of adjacent fluid. At temperatures ˜85% of T_{critical}, pressure due to fluid surface tension, σ, given by pₛ=2σrₚ, is overcome and adjacent fluid vaporizes. This creates a rapidly expanding vapor microbubble that implodes and collapses at 1-1.5 microns. Solvent vaporization further insulates the rapidly heated particle, which reduces particle cooling and melts gold (Au) NPs at lattice temperatures >529K. Explosive vaporization coincides with cavitation—strong localized pressure transients associated with irreversible fragmentation and reduced particle size as well as damage to adjacent proteins and cells. Nanoparticles may become transparent at resonant frequencies due to intense photoexcitation and ultimately vaporize. Nanoparticle suspensions must be replaced between successive laser shots in experiments to avoid accumulation of damage from the laser. Due to the above noted limitations, methods and apparatus that allow for the more efficient transfer of heat from a source of incident radiation would be an improvement in the art.

### BRIEF SUMMARY OF THE INVENTION

The present invention is directed to methods and apparatus for increasing the efficiency of converting resonant irradiation incident on surfaces such as metal, metal-coated or metal-containing particles to heat which is subsequently dissipated to surrounding environment

One example embodiment of an apparatus for increasing the heat conversion efficiency from resonant irradiation incident on metal, metal-coated or metal-containing particles to a local ambient environment comprises metal particles dispersed in the ambient environment; a source of radiation; and a means of modulating the incident radiation to increase the conversion efficiency.

One example embodiment of a method of increasing the heat conversion efficiency from resonant irradiation incident on metal, metal-coated or metal-containing particles to the ambient environment comprises irradiating metal particles with an incident radiation; modulating the incident radiation at a rate equal to or greater than the interaction rate of neighboring metal particles to prevent irreversible interaction between metal particles; and transferring heat from the metal particles to the environment.

### BRIEF DESCRIPTION OF THE DRAWINGS

It will be appreciated by those of ordinary skill in the art that the elements depicted in the various drawings are for exemplary purposes only. The nature of the present invention, including the best mode, as well as other embodiments of the present invention, may be more clearly understood by reference to the following detailed description of the invention, to the appended claims, and to the several drawings.

FIG. 1A is a schematic representation of one example of a sample cell according to the present invention.

FIG. 1B is a schematic representation of one example of an apparatus according to the present invention.

FIG. 2 is a graphical representation of the temperature in a sample cell containing a 7.9-microliter suspension of Au NPs at 0.092 g Au/m³ increases from an ambient value of 25.5° C. to an equilibrium value of 27.7° C. during a 320-second continuous-irradiation period by a 0.17-watt beam at 514 nanometers.

FIG. 3 is a graphical representation of the time constant for heat transfer from the system being determined to be τₛ=88 seconds by applying the linearized energy balance to temperature vs. time data from the cooling period of FIG. 2 (♦).

FIG. 4 is a graphical representation of the efficiency of transducing resonant irradiation to heat in a 7.9-microliter aqueous sample of suspended 20-nanometer gold NPs with (♦) and without (Δ) mechanically chopping the incident radiation at a frequency of 6000 cycles per second.

FIG. 5 is a graphical representation of the maximum equilibrium heat flux from 7.9-microliter suspensions of Au NPs increases in proportion to laser power from 0.085 to 1.5 W and NP concentration from 46 g Au/m³ (Δ) to 920 g Au/m³ (♦).

### DETAILED DESCRIPTION OF THE INVENTION

Rather than dissipate heat using high-intensity laser pulses, heat transfer by continuous wave irradiation of NP suspensions was evaluated at fluence values which are 10⁸ to 10¹¹-fold lower. Contact times >τ_{τ} were used to heat particle and adjacent media in isolated microvolumes to temperatures that were below threshold values for explosive vaporization, melting or fragmentation. Continuous wave (cw), low-intensity, resonant irradiation of Au NP at long contact times has been used to image cells by polarization interference, to measure optothermal properties of nanorods, and to inactivate tumor cells with Au-shell Si-core nanoshells, but microscale heat transport from NP suspensions and effects of NP concentration or laser power on temperature rise were not examined and optothermal transduction efficiencies were not determined. Temperatures of aqueous suspensions of 20-nanometer Au particles <10 microliters in volume that were irradiated in a vacuum by continuous wave Ar+ ion laser at 514 nm were monitored as laser power and NP concentration were varied. Microscale time constants for conductive and radiative heat transfer were determined from thermally isolated NP suspensions using the transient temperature profile. Time constants were correlated to a linearized heat transfer coefficient. This allowed determination of efficiency of NP transduction of continuous-wave, low-intensity light to bulk microvolume heat for the first time. Modulating the incident irradiation was found to have increased transduction efficiency ≧2.1-fold. The linearized heat transfer model predicted equilibrium temperature increases proportional to NP concentration at low absorbance values and to applied laser power, consistent with data. These results support development of thermal fluid meso-, micro- and nano-scale systems that incorporate NPs to transduce light to heat, including miniaturized fabricated analytical and manufacturing devices. NP transducers in such systems must be capable of efficient, repeated excitation to reproducibly generate heat over multiple cycles. In particular, there has been recent interest in nanofluids NPs suspended in base heat transfer fluids that exhibit higher, temperature-dependent thermal conductivities and critical heat fluxes relative to base fluids.

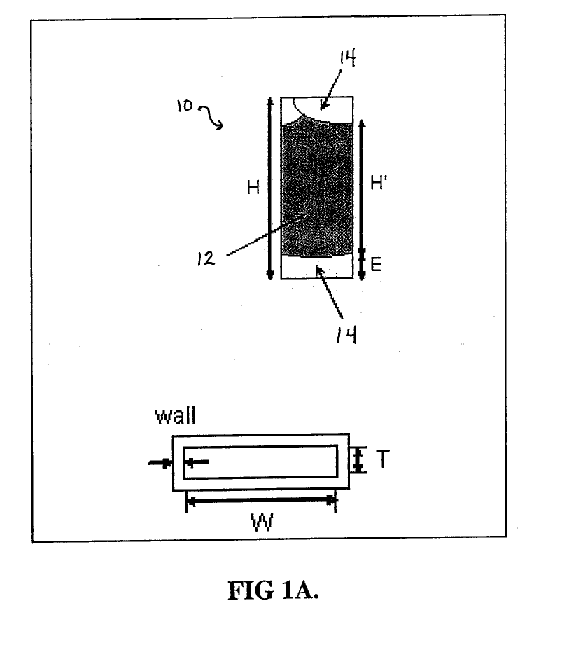

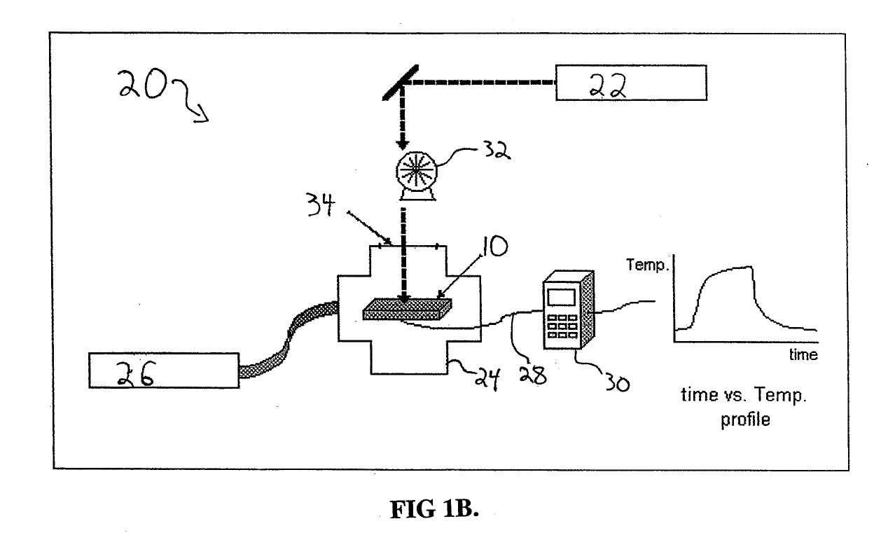

Shown in FIG. 1(a) is a schematic representation of one example of a sample cell 10 according to the present invention. Shown inside sample cell 10 are metal particles dispersed in an ambient aqueous environment 12. Sealing the ends of the sample cell are caps 14. As will be apparent to one of ordinary skill in the art, any type of end cap 14 may be used, including but not limited to epoxy. It is currently preferred that the end caps 14 be placed so as to minimize an air space or bubbles within the sample cell 10. Further shown are the height of the sample cell (H), the height of the metal particles disposed in an ambient environment 12 within the sample cell 10 (H′), the thickness of the end cap 14 (E), the width of the sample 12 within the sample cell 10 (W), and the thickness of the metal particles dispersed in an ambient environment 12 within the sample cell 10 (T).

Shown in FIG. 1(b) is a schematic representation of one example of an apparatus 20 for increasing the heat conversion efficiency from resonant irradiation incident on metal particles to the ambient environment. Shown are a sample cell 10, a source of incident radiation 22, vacuum chamber 24, a window 34 disposed in the side of vacuum chamber 24, a vacuum pump 26, a thermocouple 28, a digital thermometer 30, and a means of modulating incident radiation to increase energy transduction efficiency of the metal particles 32. Further shown is a sample cell 10 containing metal particles dispersed in an ambient aqueous environment.

As will be apparent to one of ordinary skill in the art, means of modulating incident radiation to prevent irreversible interaction such as aggregation of the metal particles 32 may be any means of controlling the duration of the incidence of and/or the time period between incidences of a particular radiation upon a set of metal particles. Examples of means for modulating incident radiation to prevent an irreversible interaction, such as aggregation of the metal particles 32 include, but are not limited to, mechanical beam choppers, electronic or optical pulse generation, or controls that turn on and off a source of incident radiation at a particular frequency or rate.

As will be apparent to one of ordinary skill in the art, the metal particles dispersed in an ambient environment 12 may comprise any sort of metal, metal-coated or metal-containing particles. Examples of metal, metal-coated or metal-containing particles include, but are not limited to, metal nanoparticles, noble metal particles, noble metal nanoparticles, metal chips, metal nanorods, metal nanotubes, metal chips, metal thin films, noble metal thin films, gold nanoparticles, gold-shell silica-core nanoparticles, nanoshells, gold nanorods, and silica chips.

As will be apparent to one of ordinary skill in the art, the ambient environment 12 in which metal particles are dispersed may comprise any sort of ambient environment in contact with the metal particles. Examples of ambient environments include, but are not limited to, solids, liquids, gases, and plasmas.

As will be apparent to one of ordinary skill in the art, dispersement of metal particles in an ambient environment 12 may comprises any sort of dispersement. Examples of dispersement include, but are not limited to, colloidal suspension or sol.

As will be apparent to one of ordinary skill in the art, the dispersed metal particles in an ambient environment 12 may or may not be SPR-active, that is, incident resonant irradiation may, or may not, induce surface plasmons or surface polaritons in the surface of the metal particles.

As will be further apparent to one of skill in the art, any source of incident radiation 22 that can heat metal particles dispersed in an ambient environment 12, which may or may not be dispersed in a sample cell 10, may be used. Examples of sources of incident radiation 22 include, but are not limited to, lasers, such as a cw Ar-Ion laser, laser diodes and incandescent sources.

As will be apparent to one of ordinary skill in the art, sample cell 10, vacuum chamber 24, window 34 disposed in the side of vacuum chamber 24, a vacuum pump 26, thermocouple 28, and digital thermometer 30 are optional components that may or may not be present in embodiments of the invention.

An example embodiment of a method of increasing the heat conversion efficiency from irradiation incident on metal particles to the ambient environment comprises irradiating the metal particles with an incident radiation; increasing transduction efficiency by modulating the incident radiation; and transferring heat from the metal particles to the environment. In one example of an embodiment, the heat conversion efficiency is increased by more than 2.1 fold.

Methods of increasing transduction efficiency by modulating the incident radiation may include, but are be limited to, modulating the incident radiation at a rate equal to or greater than the rate at which neighboring particles interact by, as nonlimiting examples, molecular diffusion, eddy diffusion, or dispersion, in order to prevent reversible or irreversible aggregation of the metal particles or any other such interaction which would decrease energy transduction efficiency of the metal particles.

As will be apparent to one of ordinary skill in the art, the metal particles may comprise any sort of metal, metal coated, or metal-containing particles. Examples of metal particles include, but are not limited to, metal nanoparticles, noble metal particles, noble metal nanoparticles, metal chips, metal nanorods, metal nanotubes, metal chips, metal thin films, noble metal thin films, gold nanoparticles, gold-shell silica-core nanoparticles, gold nanorods, and silica chips.

As will be apparent to one of ordinary skill in the art, irradiating the metal particles with an incident radiation may comprise, for example, irradiating the metal particles with a laser diode, incandescent source or laser, such as, for example, a cw Ar-Ion laser. Other examples of lasers include, but are not limited to Helium-neon lasers, Titanium-sapphire lasers, CO₂ lasers, krypton gas ion lasers, or copper metal vapor lasers.

Modulating the incident radiation may, by means of a non-limiting example, prevent aggregation of dispersed metal particles. Modulating the incident radiation may, by means of non-limiting example, comprise passing the incident radiation through a mechanical chopper, chopping the incident radiation into pulses, chopping the incident radiation at a frequency of about 6000 cycles per second, and chopping the incident radiation into pulses to create a period between pulses that longer than the thermal dissipation time of the metal particles.

In an embodiment of the invention, the incident radiation may be modulated at a rate which is equal to or faster than the rate at which adjacent particles physically interact. For example, the diffusive time constant, τ_{D}, for coagulative interactions between neighboring metal particles with Stokes-Einstein diffusivity Dₚ=κT/(6τrₚμ) separated by a diffusion length L_{D}=rₚ(ρₚ/x_{Au})^{1/3} may be estimated from τ_{D}=L_{D}²/Dₚ as:

$${τ}_{D} = \frac{6 π μ {{r}_{p}^{3} ( \frac{{ρ}_{p}}{{x}_{Au}} )}^{2 / 3}}{κ T}$$

where κ is Boltzmann's constant and μ is matrix viscosity. NP suspensions at x_{Au}=920 g m⁻³ have a diffusive interaction time of τ_{D}=0.35 milliseconds, which corresponds to ˜1×10⁶ interactions per particle per 320-second irradiation period, T₁. At v=6000 cycles per second, the chopping frequency is 0.167 milliseconds—less than half the diffusive interaction time at x_{Au}=920 g m⁻³. Between successive chopped pulses, NP temperatures relax rapidly with short thermal dissipation times of τ_{d}˜27-79 picoseconds (eqs 3-4). Therefore, when laser light is chopped, NP-NP interactions are less likely to result in coagulation.

The present invention is further described in the following examples, which are offered by way of illustration and are not intended to limit the invention in any manner.

### Examples

### Example 1

### Experimental Design

Gold colloid purchased from Sigma (G 1652, St. Louis, Mo., USA) 20 nm in diameter and ˜0.01% w/v HAuCl₄ (0.0046% w/v Au NP) was used. Colloid was concentrated by centrifugation at 12,000 rpm for 15-20 minutes (Marathon Model 13K/M, Fisher Scientific, Hampton, N.H., USA) and resuspended in distilled, deionized (18 MΩ, Millipore Corp, Bedford, Mass., USA), vacuum-degassed water. Vacuum-resistant sample cells, were fabricated from borosilicate glass rectangle tubing (Fiber Optic Center, New Bedford, Mass., USA). Tubing had inner dimensions of 0.2×4.0×15.9 mm (thickness×width×height) with a wall thickness of 0.2 mm. Cells were cleaned with ethanol (Aaper Alcohol and Chemical Co., Shelbyville, Ky., USA) prior to use. One end of the glass tubing was sealed with 5 Minute Epoxy and Hardener (Devcon, Danvers, Mass., USA), to a depth of ˜3.0 mm. The opposite end was partially sealed to allow insertion of Au colloid solution through a small opening with a pipette after drying the epoxy. Injected colloid completely displaced air in the cell and the opening was sealed with epoxy.

A cw Ar-Ion laser (514 nm and 488 nm, BeamLok™ 2060&2080, Spectra-physics, Mountain View, Calif., USA) was used to irradiate the sample through a quartz window in the vacuum chamber. A sample cell was suspended inside the vacuum chamber by a K-type chrom-alumel thermocouple (0.003 inches, Omega, Stamford, Conn., USA) connected to a digital thermometer (Omega HHS09R, Stamford, Conn., USA). Pressure in the chamber was reduced to <1 Torr to eliminate convective heat transfer from the surface of the sample cell. A mechanical chopper (HMS model 220) with 60 slots and frequency control from 0 to 6000 rpm was used to modulate irradiation in some experiments. UV-vis absorbance spectra of samples were obtained using a Perkin-Elmer spectrophotometer (Lambda-9, Wellesley, Mass., USA). Data presented graphically are average values±one standard deviation (error bars).

### Example 2

### Sample Time vs. Temperature Curve for Sample Undergoing Radiation

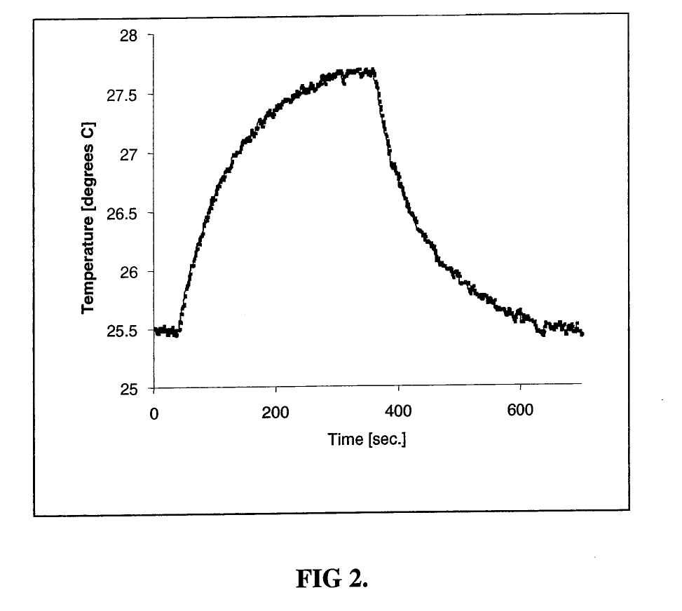

A typical plot of temperature versus time obtained from cw irradiation of an optically transparent microliter sample cell filled with NP suspension and thermally isolated inside a vacuum chamber is shown in FIG. 2. The sample was a rectangular borosilicate glass cell containing a volume of 7.9 microliters consisting of 0.092 g of 20-nm Au NPs per 100 milliliters of distilled, deionized, degassed water. The cell was epoxy sealed and suspended in a vacuum chamber by a 2″-long, 0.003″-OD chrom-alumel thermocouple (TC). The sample thermally equilibrated with the surrounding vacuum chamber before exposure to the laser during a minimum delay period of 30 seconds. Resonant irradiation at a wavelength of 514 rim at a nominal power of 0.17 W in a spot size of 3 mm diameter (fluence of 2.4 W/cm²) was applied using a cw Ar⁺ ion laser. The laser beam was mechanically chopped at a rate of 6000 rpm, reducing the incident power from a nominal value of 170 mW to an effective value of 85 mW. Temperature increased in this experiment from an ambient value of T_{amb}=25.5° C. to a maximum equilibrium value of Tₘₐₓ=27.7° C. after 320 seconds of exposure. After a short equilibration period at Tₘₐₓ, irradiation by the cw laser was discontinued and the sample was allowed to cool, returning to a value of T_{amb}=25.5° C. in equilibrium with its surroundings. Temperature data were fit to a linearized energy balance derived from a description of microscale thermal dynamics in the NP suspension to determine the efficiency of transducing light to heat in bulk suspensions of Au NPs.

### Example 3

### Thermal Dynamics in Irradiated NP Suspensions.

NP temperature, Tₚ during excitation increases with NP diameter from 5 to 50 nm in proportion to pump laser flux (intensity, Iₒ/spot size, σ), relative energy absorption calculated from sample absorbance (A) by Beers Law and inversely proportional to sample heat capacity, Cₚ, Au concentration, [Au], and cell pathlength, 1:

$$Δ T ∝ \frac{{I}_{o} ( 1 - {10}^{- A} )}{σ [ Au ] {C}_{p} l} \qquad ( 1 )$$

High-power regeneratively amplified Ti:sapphire lasing yielded ΔT from 40 to 160 K in 15-nm Au NP with a single 120 fs pulse; whereas low-intensity cw irradiation of Au NP yielded ΔT from 15° C.⁷ to about 30° C. in times ranging from 5 seconds to 6 minutes. Resonant energy absorbed by NP electrons dissipates in pico- to nanoseconds across the particle-matrix interface to a surrounding adjacent medium layer at temperature Tₛ, at a rate dependent on particle-size, pump-power and environmental conditions according to:

$$\frac{{T}_{p} ( t ) - {T}_{s}}{{T}_{i} - {T}_{s}} = exp \{ - {( t / {τ}_{d} )}^{β} \} \qquad ( 2 )$$

In eq 2, Tᵢ is initial particle temperature, τ_{d} is a characteristic time scale for temperature dissipation, and β is a phenomenological constant. For negligible heat-transfer resistance across the particle-matrix interface, τ_{d}, is estimated by equating heat capacity of radius rₚ particles (4/3τrₚ³Cₚρₚ) to heat capacity of adjoining thermal diffusion layer (4τrₚ²l_{d}C_{f}ρ_{f}) of thickness l_{d}=(α_{f}τ_{d})^{1/2}, where α_{f} is fluid thermal diffusivity, α_{f}≡k_{f}/ρ_{f}C_{f}:

$${τ}_{d} = \frac{{r}_{p}^{2} {C}_{p}^{2} {ρ}_{p}^{2}}{9 {C}_{f} {ρ}_{f} {k}_{f}} \qquad ( 3 )$$

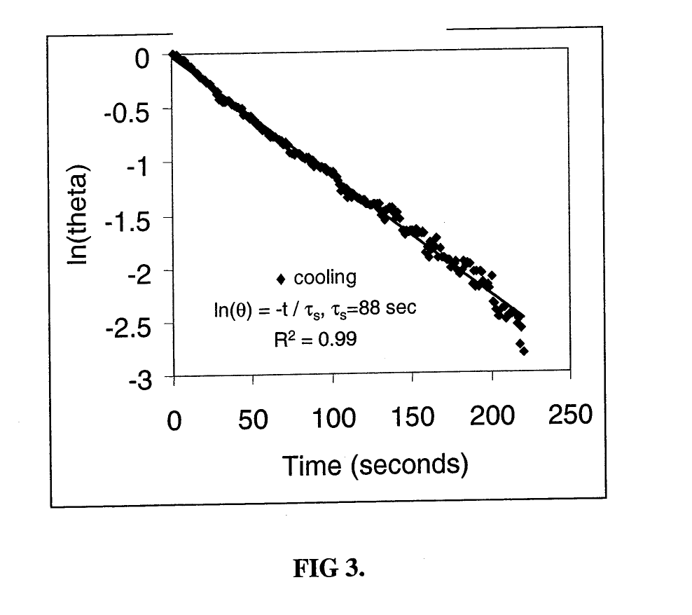

Hu and Hartland observed β=0.6 for 2rₚ=5 to 15 nm and β=0.7 for 2rₚ=26 to 50 nm particles, respectively, and reported τ_{d}=0.64 picoseconds nm⁻²×rₚ² for rₚ in nm at high pump power, consistent with quadratic dependence of cooling time on particle radius given by eq 3. In the limit of negligible interface resistance, estimated temperature dissipation rate for the system shown in FIG. 3 is between 27 picoseconds (eq. 3) and 64 picoseconds.

When interface thermal conductance, G, which has units of Wm⁻²K⁻¹, is much slower than conductance in the adjacent medium, i.e. G<<3C_{f}ρ_{f}k_{f}/(rₚCₚρₚ), β reduces to unity and the controlling interface thermal conductance replaces conductance by the adjacent medium in eq 3:

$${τ}_{d} = \frac{{r}_{p} {ρ}_{p} {C}_{p}}{3 G} \qquad ( 4 )$$

Wilson et al. reported that dodecanethiol-terminated Au NP with 2rₚ=3-5 nm exhibited G˜20 MW m⁻²K⁻¹, which delayed energy exchange between surface Au atoms and surrounding molecules. Plech et al. obtained G=105±15 MW m⁻²K⁻¹ for an aqueous sol of Au NP excited at low power (14.7 mW or 529 K) by fitting decay of lattice expansion measured by time-resolved x-ray scattering Tₚ(t). This was consistent with nanosecond-scale values of τ_{d}∝rₚ^{1.46} which were intermediate between adjacent medium-limited and interface-limited conduction. Fragmentation, melting, and gas-layer formation at NP surfaces induced by high-power irradiation were postulated to decrease heat transfer rates. For slow interface conductance in the absence of these effects, estimated temperature dissipation rate for our system using G=105±15 MW m⁻²K⁻¹ is 79 picoseconds.

### Example 4

### Energy Balance on Irradiated Sample

A continuum energy balance on the system in FIG. 1 consisting of an aqueous Au NP suspension within a borosilicate glass sample cell inside a vacuum chamber that is irradiated by a laser gives

$${\sum }_{i} {m}_{i} {C}_{p , i} \frac{d T}{d t} = {\sum }_{j} {Q}_{j} \qquad ( 5 )$$

where the i terms mᵢC_{p,i} are products of mass and heat capacity of system components (AuNP suspension, sample cell and epoxy), T is aggregate system temperature and t is time. The j energy terms Qⱼ include laser-induced energy source term, Qₗ and Qₒ as well as conduction, Q_{cond}, and radiation, Q_{rad}, energy outputs. Eq5 is valid when thermal equilibrium within the system is attained much faster than energy exchange with surroundings. This is confirmed later by showing a time constant for internal thermal equilibration is substantially smaller than the equilibrium time constant for heat transfer with the surroundings that will be obtained from eq 5.

Laser-induced source term Q_{I} represents heat dissipated by electron-phonon relaxation of plasmons on the Au surface induced by laser irradiation of Au NP at resonant wavelength λ:

Q₁=I(1-10^{-A}^{_{λ}})η_{T} (6)

where I is incident laser power, η_{T} represents the efficiency of transducing incident resonant absorbance to thermal energy via plasmons, and A_{λ}is absorbance of NP in the borosilicate glass sample cell at wavelength λ given by Beer-Lambert's Law, A_{λ}=ε_{λ}Lc, where ε_{λ} is wavelength-dependent molar absorptivity, L is pathlength and c is molar concentration. Source term Qₒ represents heat dissipated from light absorbed by the quartz sample cell itself. It was measured independently to be Qₒ=(5.4×10⁻⁴)l in J s⁻¹ using borosilicate glass cell containing aqueous samples without NP.

Conduction energy outputs Q_{cond,air} and Q_{cond,TC} correspond to heat conduction away from the system surface by air and thermocouple (TC) wires, respectively, given in general for a single dimension by:

$${Q}_{cond} = \frac{kA}{L} ( T - {T}_{amb} ) \qquad ( 7 )$$

where k is thermal conductivity, A is area cross-section perpendicular to conduction, L is the conduction length between system and surroundings, and T_{amb} is the ambient temperature of the surroundings. Radiation energy output term Q_{rad} corresponds to energy radiation from the surface:

Q_{rad}=Aεσ(T⁴−T_{amb}⁴) (8)

where ε is emissivity, σ is Stefan-Boltzman constant, and A is surface area for radiative heat transfer. The transduction efficiency, η_{T}, may be obtained by numerically fitting eqs 5-8 to the temperature distribution in FIG. 1. However, for temperature increases ≦11K examined in this study, the ratio Q_{rad}/(T-T_{amb}) factored out from eq 8 remains constant to within 2.8%. This fact allows a convenient linearization of the energy balance using a heat transfer model with a relatively constant coefficient of Aεσ(T+T_{amb})(T²+T²_{amb}) for the radiation term. The heat transfer model permits straightforward analytical determination of η_{T}.

### Example 5

### Heat Transfer Equation for Sample Cell and Contents

External heat flux in the system, Qₑₓₜ, is nearly proportional to linear thermal driving force, with a heat transfer coefficient, h, as the proportionality constant:

Qₑₓₜ=hA(T−T_{amb}) (9)

In this case the energy balance in Eq 5 simplifies to:

$${\sum }_{i} {m}_{i} {C}_{p , i} \frac{d T}{d t} = {Q}_{I} + {Q}_{o} - {Q}_{ext} \qquad ( 10 )$$

Introducing a dimensionless driving force temperature, θ, scaled using the maximum system temperature, Tₘₐₓ,

$$θ ≡ \frac{{T}_{amb} - T}{{T}_{amb} - {T}_{m ax}} \qquad ( 11 )$$

and a sample system time constant τₛ;

$${τ}_{s} ≡ \frac{{\sum }_{i} {m}_{i} {C}_{p , i}}{hA} \qquad ( 12 )$$

which are substituted into eq 10 and rearranged to yield

$$\frac{d θ}{d t} = \frac{1}{{τ}_{s}} [ \frac{{Q}_{I} + {Q}_{o}}{hA ( {T}_{m ax} - {T}_{amb} )} - θ ] \qquad ( 13 )$$

When laser irradiation ceases, Q_{I}+Qₒ and the system cools, reducing eq 13 to

$$\frac{d θ}{d t} = \frac{- θ}{{τ}_{s}} \qquad ( 14 )$$

Eq 14 may be solved using the initial condition θ=1 at t=0 to give

$$θ = exp ( \frac{- t}{{τ}_{s}} ) \qquad ( 15 )$$

During laser irradiation, Q_{I}+Qₒ is finite and system temperature rises to a maximum value when external heat flux given by eq 9 equals heat input via laser transduction given by eq 6:

Q_{I}+Qₒ=hA(Tₘₐₓ−T_{amb}) (16)

Substituting eq 16 into eq 13 gives

$$\frac{d θ}{d t} = \frac{1}{{τ}_{s}} ( 1 - θ ) \qquad ( 17 )$$

Eq 17 can be solved using the initial condition θ=0 at t=0 to give

θ=1−exp(−t/τₛ) (18)

### Example 6

### Determine Thermal Equilibrium Time Constant and Heat Transfer Coefficient of the System

The linear temperature driving force approximation in eqs 9-13 permits system equilibration time, τₛ, and heat transfer coefficient, h, to be estimated using system parameters from cooling data (via eq 15) and/or heating data (via eq 18). Parameter values for our system were: A_{rad}=A_{cond,cell}=164 mm²; ε=0.8; σ=5.67×10⁻⁸ W/m²K⁴; L_{TC}=0.05 m; A_{TC}=9×10⁻⁹m²; kₐᵢᵣ^{1Torr}=2.63×10⁻W/mK; kₐᵢᵣ^{0.3Torr}=7.89×10⁻W/mK; k_{chrom}=93.7 W/mK; kₐₗᵤₘ=237 W/mk; x_{Au}=46 g Au per m³ aqueous suspension at 1× concentration or 920 g Au per m³ at 20× concentration; rₚ=10 nm; r_{L}=1.5 mm; λ=514 nm; A_{λ}=0.186 at 920 g Au/m³; ΣᵢmᵢC_{p,i}=0.0946 J/K; and ρ_{Au}=19.3 g/cm³.

FIG. 3 shows a time constant for heat transfer of τₛ=88 seconds determined as the negative reciprocal slope of In(θ) vs. t (eq 15) using temperature versus time data recorded during cooling in FIG. 2. Data were truncated at 220 seconds to avoid scatter as the logarithmic operand approached zero. Evaluating time constants with cooling data avoided effects of thermal gradients during heating. Temperature in the system dissipated at a rate inversely proportional to the internal equilibration time, τᵢₙₜₑᵣₙₐₗ=(L²/α)ᵢₙₜ. During cooling, a value of τᵢₙₜₑᵣₙₐₗ=4.5 seconds was determined for internal equilibration time using L=2 mm (half the cell width) and α_{glass}=8.8×10⁻⁷ m²s⁻¹ , since α_{glass}/α_{H2O}=6 for a thermal conductivity of k_{NP}˜1.01*k_{H2O} for our 0.0048% v/v Au NP suspension. Since τᵢₙₜₑᵣₙₐₗ/τₛ ˜0.05, the temperature remains essentially uniform across the heat transfer surface area, A, which validates use of eq 5.

An average time constant of τₛ=86.3±8.61 seconds (N=37) was obtained for thermal equilibration with the surroundings via conductive and radiative heat transfer. This value is 10¹²-fold larger than equilibration times for heat dissipation from thermally excited NPs calculated using eqs 3-4, which tells us that monitored changes in the system temperature are representative of irradiated NP temperatures which are equilibrated with surrounding fluid. The time constant value of τₛ=86.3±8.61 seconds was substituted into eq 12 to estimate an average heat transfer coefficient for our sample cell of h=7.02±0.6 Wm⁻² K⁻¹. This value is 37% larger than an effective heat transfer coefficient of 5.1 Wm⁻¹ K⁻¹ calculated for radiation alone in our system, because of added heat transfer by conduction (eq 7) which occurs at a rate about half that of radiation (eq 8).

### Example 7

### Determine Efficiency of Transducing Resonant Light to Heat Using Suspended Nanoparticles

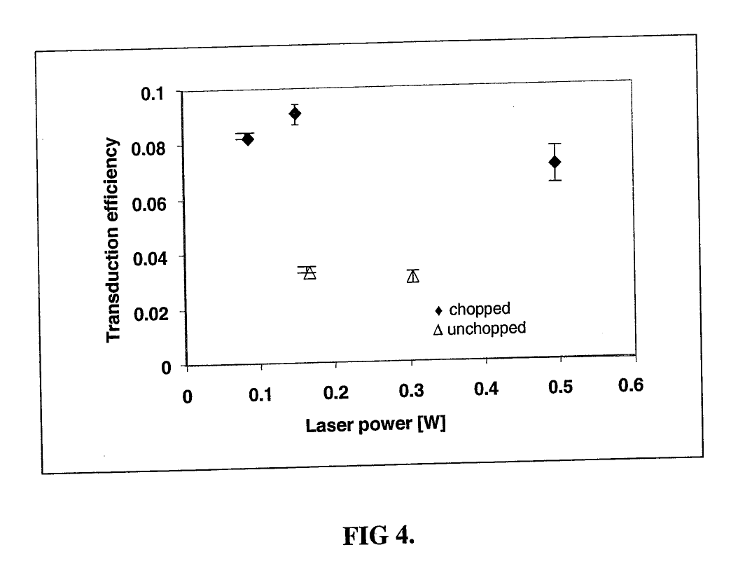

From measured values of h, the transduction efficiency, η_{T}, may be determined by substituting eq 6 for Q_{I} into eq 16 and rearranging to get

$${η}_{T} = \frac{hA ( {T}_{m ax} - {T}_{amb} ) - {Q}_{o}}{I ( 1 - {10}^{- {A}_{λ}} )} \qquad ( 19 )$$

where Qₒ was measured independently to be Qₒ=(5.4×10⁻⁴)I in J s⁻¹ using borosilicate glass cells containing aqueous samples without NP. FIG. 4 shows values of transduction efficiency calculated using eq 19 for data obtained with (♦) and without (Δ) mechanically chopping the irradiation laser beam at a frequency, v, of 6000 cycles per second. Error bars for each data point correspond to ±1 standard deviation. Chopping the laser increased transduction efficiencies ≧2.1-fold.

Irradiation at 514 nm, rather than 525 nm, in our system decreases the likelihood that plasmon bleaching might decrease laser-to-heat transduction and reduces convolution of measured efficiency by NP aggregation. Plasmon bleach exhibited by excited electrons transiently lowers the Au NP absorption spectra at its maximum, ˜524 nm, while raising absorption at its wings, ˜475 and 575, respectively. The value of A₅₁₄ falls between the maximum and the wings at a point where transient absorption remains relatively constant. Irradiation at 514 nm also yields monotonically decreasing absorption in the event of NP aggregation. Because aggregration both broadens and red-shifts the spectra, absorption between 524 and 575 nm can fluctuate nonmonotonically in proportion to the degree of aggregation.

Continuous-wave irradiation of aqueous Au NP suspensions at low power allows even heating with reproducible efficiencies at temperatures within physiological limits, whereas high-power nano-, pico- and femto-second pulses produce large particle-to-matrix temperature gradients that cause vaporization and concomitant cavitation and NP fragmentation, which are incompatible with biological or steady-state applications, and yield variable efficiencies. Resonant plasmon decay by radiative or scattering processes that divert laser light absorbed by NP from producing heat are minimized by using spherical NP between about 10 and 20 nm in diameter.

Only dipole oscillations contribute significantly to extinction in this size range, so localized surface plasmon resonance is independent of particle size. In this size range electron-surface scattering also increases the overall electron-phonon cross-section by 10%. Certain irradiation frequencies can enhance photoluminescence in nanorods or clusters <5 nm to lower heating efficiencies relative to spheres. On the other hand, broad spectral absorbances characteristic of nanorods and nanoshells can increase absorption magnitudes across a broader range of incident wavelengths, allowing excitation within the near-infrared ‘water window’, for example. The extensive parameter space provided by this rich set of variables is useful to optimize laser-to-heat transduction via NP in non-homogeneous suspensions, solids or gases where variations due to lattice-induced changes in interface thermal conductance are anticipated. Measuring transduction efficiencies can identify underlying physical phenomena that effect microscale thermal transport, permitting optimization, and allow prediction of heat flux from incident irradiation and NP concentration.

### Example 8

### Modulating Irradiation Reduces Nanoparticle Aggregation

Mechanically chopping the incident irradation decreases NP-NP aggregation, which increases laser-to-heat transduction. Negatively-charged ions on NP surfaces form an electric double layer that produces a repulsive electrostatic potential, which stabilizes NPs at interparticle distances (surface to surface) over a few nanometers. Resonant cw irradiation accelerates aggregation of 10-nm colloidal Au in aqueous and organic' suspensions. Aggregation is more likely to arise from photoionization of NP, which reduces Derjaguin-Landau-Verwey-Overbeek electrostatic stabilization, than from induction of optical attractive forces, which occurs at applied intensities >10⁶ W/cm². Coagulation of NPs without coalescence is reported at radiation wavelengths of 514 nanometers. Spectral broadening, red-shifting and lowered absorbance at 514 nm after unmodulated cw laser irradiation, was measured consistent with previous reports. Delivering eight times as much laser power to a modulated sample lowered its relative absorbance by just one-third of the unmodulated amount.

Reducing aggregation by chopping incident light is also consistent with time constants in our system. The diffusive time constant, τ_{D}, for coagulative interactions between neighboring Au NP with Stokes-Einstein diffusivity Dₚ=κT/(6τrₚμ) separated by a diffusion length L_{D}=rₚ(ρₚ/x_{Au})^{1/3} may be estimated from τ_{D}=L_{D}²/Das:

$${τ}_{D} = \frac{6 π μ {{r}_{p}^{3} ( \frac{{ρ}_{p}}{{x}_{Au}} )}^{2 / 3}}{κ T} \qquad ( 20 )$$

where κ is Boltzmann's constant and μ is matrix viscosity. NP suspensions at x_{Au}=920 g m⁻³ have a diffusive interaction time of τ_{D}=0.35 milliseconds, which corresponds to ˜1×10⁶ interactions per particle per 320-second irradiation period, T_{I}. At v=6000 cycles per second, the chopping frequency is 0.167 milliseconds—less than half the diffusive interaction time at x_{Au}=920 g m⁻³. Between successive chopped pulses, NP temperatures relax rapidly with short thermal dissipation times of τ_{d}˜27-79 picoseconds (eqs 3-4). Therefore, when laser light is chopped, NP-NP interactions are less likely to result in coagulation. Slower chopping frequencies decrease transducion efficiency, as expected. Aggregation does not influence the system heat transfer time constant, τₛ, since values of mass, heat capacity, heat transfer area and radiative/conductive heat transfer coefficient in eq 12 are system properties that are unaffected by NP aggregation. When absorbance at the incident wavelength of 514 nm, A₅₁₄, is reduced by aggregation, the fraction of incident light absorbed, (1-10^{-A}), in eq 6 is decreased. This decreases transduction of incident laser light, I, to heat, Q_{I}. This appears in FIG. 4 as a decrease in transduction efficiency.

### Example 9

### Laser Power and Nanoparticle Concentration Increase Equilibrium Heat Flux

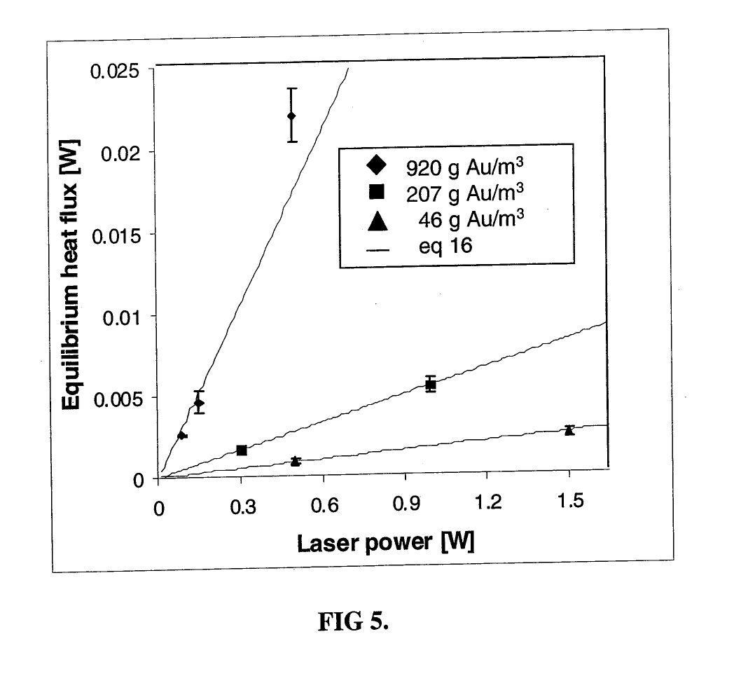

The maximum attainable heat flux due to incident radiation on a NP suspension, Qₘₐₓ=hA(Tₘₐₓ−T_{amb}), may be predicted as a function of laser power and NP concentration by substituting eq 6 into eq 16 and solving for Qₘₐₓ. FIG. 5 compares measured increases in maximum attainable heat flux of irradiated NP suspensions at 46 g Au per cubic meter (♦) and at 920 g Au per cubic meter (Δ) with predicted values (−) from eqs 6 and 16. Maximum heat flux rises in proportion to applied laser power and nearly in proportion to concentration up to absorbance values of about ˜0.1. Above absorbance values of 0.1, increasing concentration produces less than proportional increases in Qₘₐₓ, due to the logarithmic absorbance dependence of the fraction of incident radiation that is absorbed, 1-10^{-A}.

While this invention has been described in certain embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

All references, including publications, patents, and patent applications, cited herein are hereby incorporated by reference to the same extent as if each reference were individually and specifically indicated to be incorporated by reference and were set forth in its entirety herein.

The references discussed herein are provided solely for their disclosure prior to the filing date of the present application. Nothing herein is to be construed as an admission that the inventors are not entitled to antedate such disclosure by virtue of prior invention.

What is claimed is:

1. A method of increasing the heat conversion efficiency from irradiation incident on particles comprising a metal to the ambient environment, the method comprising:
irradiating the particles comprising a metal with an incident radiation;
increasing energy transduction efficiency; and
transferring heat from the metal particles to the environment.

2. The method according to claim 1, wherein increasing energy transduction efficiency comprises preventing aggregation of the particles comprising a metal.

3. The method according to claim 1, wherein the particles comprising a metal comprise particles selected from the group consisting of metal nanoparticles, metal-containing particles, metal-coated particles, noble metal particles, noble metal nanoparticles, metal chips, metal nanorods, metal nanotubes, metal chips, metal thin films, noble metal thin films, nanoshells, gold nanoparticles, gold-shell silica-core nanoparticles, gold nanorods, and silica chips.

4. The method according to claim 1, wherein the incident radiation is a laser.

5. The method according to claim 4, wherein the laser is a cw Ar-Ion laser.

6. The method according to claim 1, wherein the heat conversion efficiency is increased by more than 2.1 fold.

7. The method according to claim 1, wherein irradiating the particles comprising a metal with an incident radiation comprises modulating the incident radiation.

8. The method according to claim 7, wherein modulating the incident radiation prevents irreversible aggregation of the particles comprising a metal.

9. The method according to claim 7, wherein modulating the incident radiation comprises passing the incident radiation through a mechanical chopper.

10. The method according to claim 8, wherein modulating the incident radiation comprises chopping the incident radiation into pulses.

11. The method according to claim 8, wherein modulating the incident radiation comprises chopping the incident radiation at a frequency of about 6000 cycles per second.

12. The method according to claim 10, wherein the period between pulses is approximately equal to or longer than the thermal dissipation time of the particles comprising a metal.

13. The method according to claim 10, wherein the period of an incident irradiative pulse is less than or approximately equal to the diffusive or dispersive interaction time between neighboring particles comprising a metal.

14. An apparatus for increasing the efficiency of converting energy from irradiation incident on particles comprising a metal to an ambient environment, the apparatus comprising:
particles comprising a metal dispersed in the ambient environment;
a source of radiation; and
a means of modulating the incident radiation.

15. The apparatus according to claim 14, wherein the means of modulating the incident radiation comprises a mechanical chopper, an electronic or optical pulse generator, and/or controls that turn on and off the source of radiation at particular frequency or rate.

16. The apparatus according to claim 14, wherein the source of radiation comprises a laser.

17. The apparatus according to claim 16, wherein the laser comprises a cw Ar-Ion laser.

18. The apparatus according to claim 14, wherein the ambient environment comprises a solid, a liquid, a gas, or a plasma.

19. The apparatus according to claim 14, wherein the particles comprising a metal are selected from the group consisting of metal nanoparticles, metal-containing particles, metal-coated particles, noble metal particles, noble metal nanoparticles, metal chips, metal nanorods, metal nanotubes, metal nanoshells, metal chips, metal thin films, noble metal thin films, gold nanoparticles, gold-shell silica-core nanoparticles, gold nanorods, and silica chips.

20. The apparatus according to claim 14, wherein the particles comprising a metal are dispersed in a colloidal suspension.
